(19) United States
(12) Patent Application Publication
(10) Pub. No.: US 2015/0087185 A1
(43) Pub. Date: Mar. 26, 2015

(54) ACCESSORY CONNECTOR

(71) Applicant: KUANG YING COMPUTER EQUIPMENT CO., LTD., New Taipei City (TW)

(72) Inventors: CHUN-TE CHANG, New Taipei City (TW); HSUAN-HO CHUNG, New Taipei City (TW); YU-HUNG LIN, New Taipei City (TW); YI-HUNG YU, New Taipei City (TW)

(73) Assignee: KUANG YING COMPUTER EQUIPMENT CO., LTD., New Taipei City (TW)

(21) Appl. No.: 14/035,920

(22) Filed: Sep. 24, 2013

(51) Int. Cl. H01R 31/06

(52) U.S. Cl. CPC H01R 31/06
USPC 439/607.01; 439/660

(57) ABSTRACT

An accessory connector generally includes a plurality of metal conductive terminals, which is arranged not to contact each other so as to form individual pins; a first insertion port, which is formed at one end of the accessory connector; and a second insertion port, which is formed at an opposite end of the accessory connector and is in electrical connection with the first insertion port. The first and second insertion ports can be respectively in a plug form or a socket form. When it is desired to make a conversion into a different type of insertion port, the conversion can be achieved through electrical connection of the first insertion port to the second insertion port via the metal conductive terminals so as to achieve the purpose of conversion of connector.

### TECHNICAL FIELD OF THE INVENTION

The present invention generally relates to a connector, and more particularly to an accessory connector that provides conversion between different configurations or specifications.

### DESCRIPTION OF THE PRIOR ART

USB connectors are commonly used. Almost each type of electronic device includes a USB connector. However, due to the current prevailing and use of connectors, besides the USB connectors, micro USB connectors of which the size is even smaller than the USB connectors are also available and are commonly installed and used in electronic devices, such as the smart phones for transmission of information. However, any attempt to connect a USB connector to a micro USB connector will certainly fail due to the difference of size and this makes it impossible for interconnection and data transmission between two different electronic devices may be prohibited. This is certainly inconvenient to the users.

Thus, it is a challenge for the present inventor and the manufacturers of the business to overcome the above discussed problems.

### SUMMARY OF THE INVENTION

In view of the above-discussed problems, the present invention aims to provide an accessory connector that allows for conversion between connectors of different types or specifications.

The primary object of the present invention is that through conversion of female/male, male/male, or female/female achieved between a first insertion port and a second insertion port, even there is only a USB interface or a micro USB interface available in a specific condition, the conversion into a micro USB interface or a USB interface can be made for proceeding with data communication.

To achieve the above object, the present invention is of a structure that generally comprises a plurality of metal conductive terminals. The metal conductive terminals are arranged not to contact each other to form individual pins. The metal conductive terminals provide information connection between the first insertion port and the second insertion port, wherein the conversion between the first insertion port and the second insertion port can be a combination of a plug and a socket, a combination of a plug and a plug, or a combination of a socket and a socket. The plug and socket can be of a USB interface or a micro USB interface. To interconnect and convert into another type of insertion port, transmission can be made from the first insertion port through the metal conductive terminals to the second insertion port to achieve the conversion thereby achieving the purpose of conversion of connector.

With the above technique, the drawback of the known connectors that conversion of specifications between connectors is not available can be overcome to achieve the above-described advantages of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a combination of a USB socket and a micro USB plug.

FIG. 2 is another perspective view showing the combination of a USB socket and a micro USB plug.

FIG. 3 is a top plan view showing the combination of a USB socket and a micro USB plug with casing removed but shown in dashed line to illustrate inside details.

FIG. 4 is a perspective view illustrating an operation of opening a cover.

FIG. 5 is a perspective view illustrating an operation for connection with a USB plug and a micro USB socket.

FIG. 6 is a perspective view showing completed connection with the USB plug and the micro USB socket.

FIG. 7 is a perspective view showing a combination of a USB plug and a USB plug.

FIG. 8 is a top plan view showing the combination of a USB plug and a USB plug with casing removed but shown in dashed line to illustrate inside details.

FIG. 9 is a perspective view showing a combination of a USB socket and a USB socket.

FIG. 10 is a top plan view showing the combination of a USB socket and a USB socket with casing removed but shown in dashed line to illustrate inside details.

FIG. 11 is a perspective view showing a combination of a micro USB socket and a USB plug.

FIG. 12 is a perspective view showing a combination of a micro USB plug and a micro USB plug.

FIG. 13 is a perspective view showing a combination of a micro USB socket and a micro USB socket.

FIG. 14 is a perspective view showing a combination of a USB socket and a micro USB socket.

FIG. 15 is a perspective view illustrating an operation of sideways rotation of a cover.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

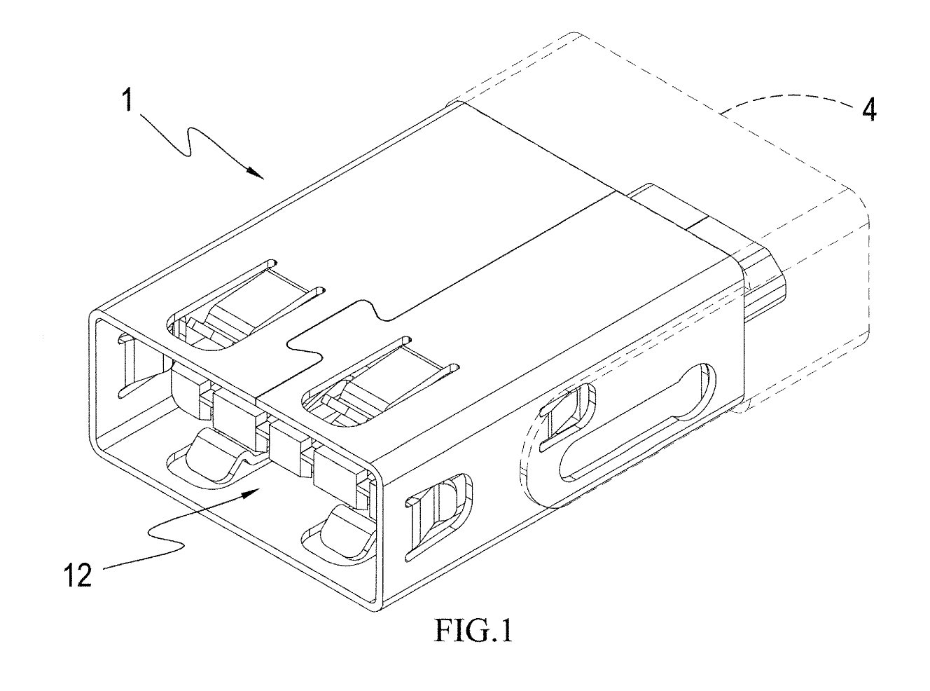

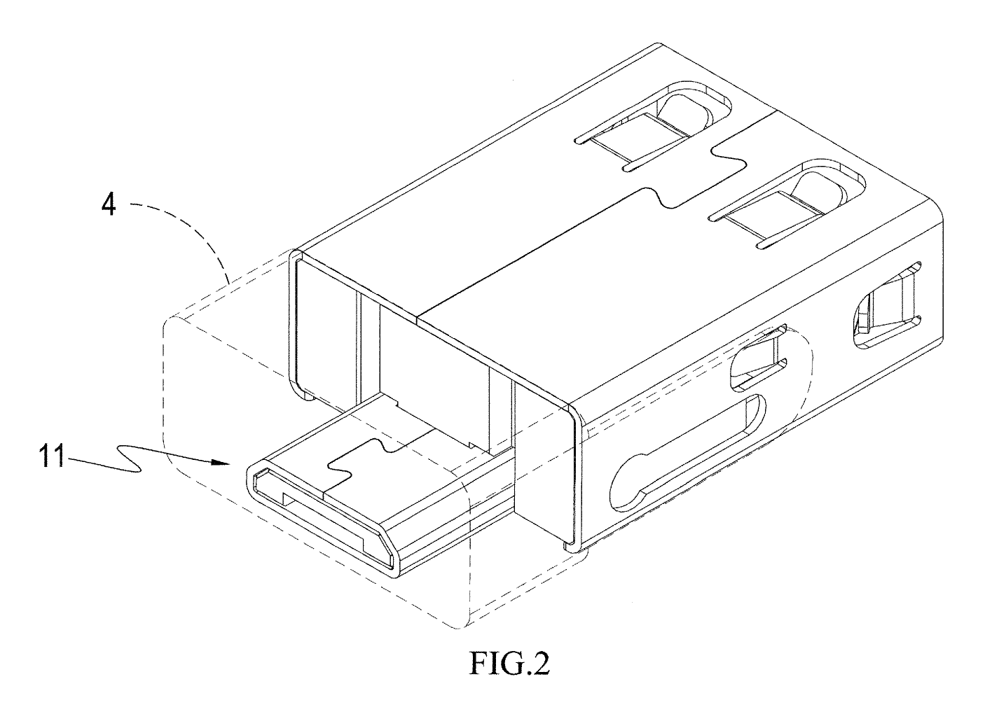

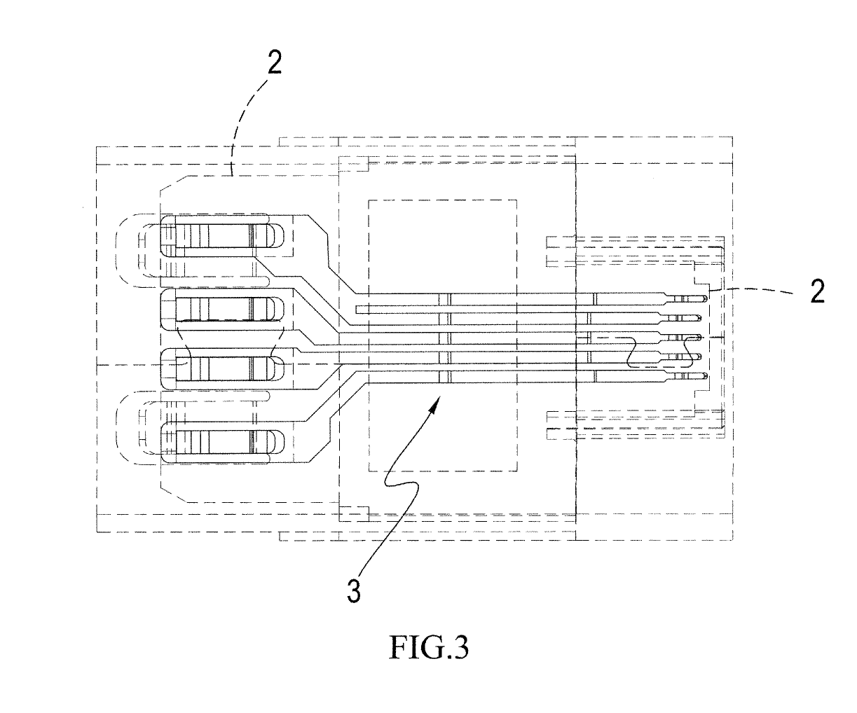

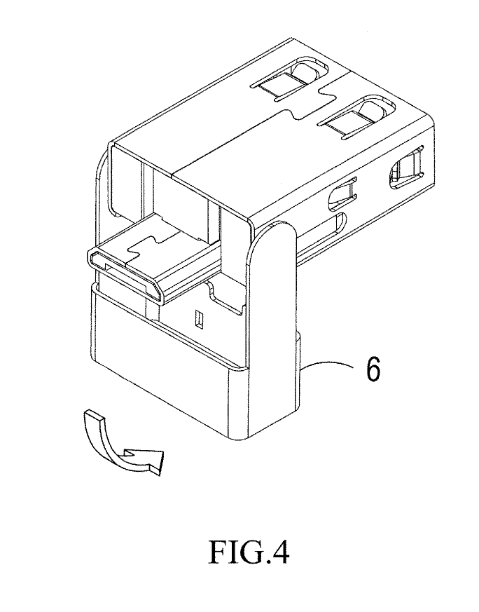

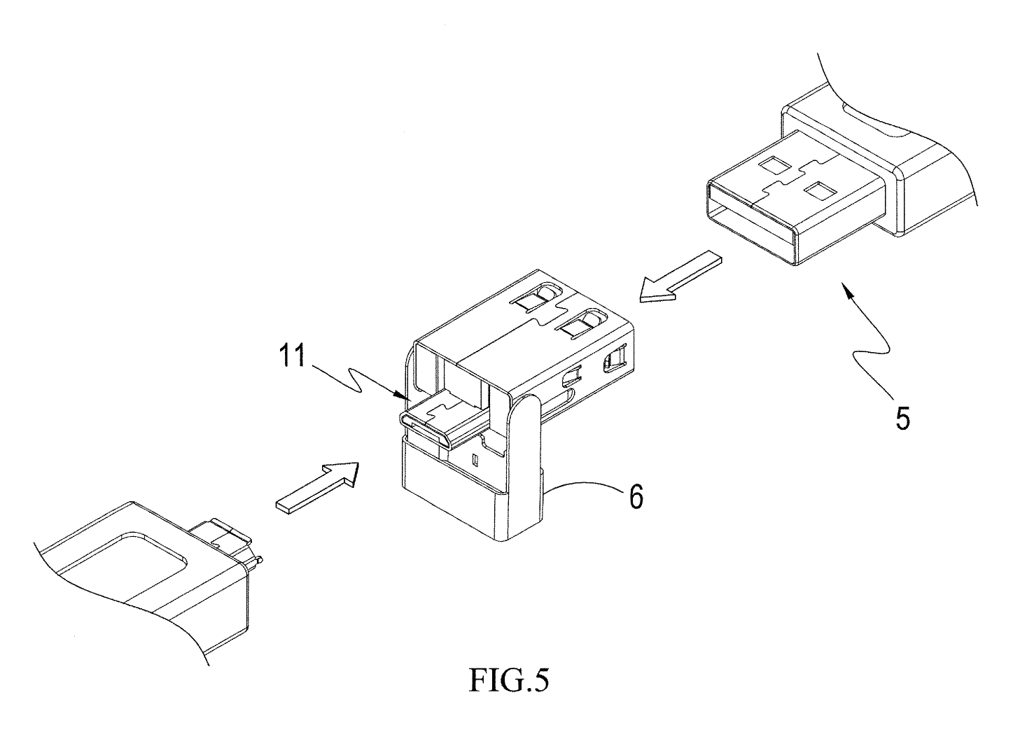

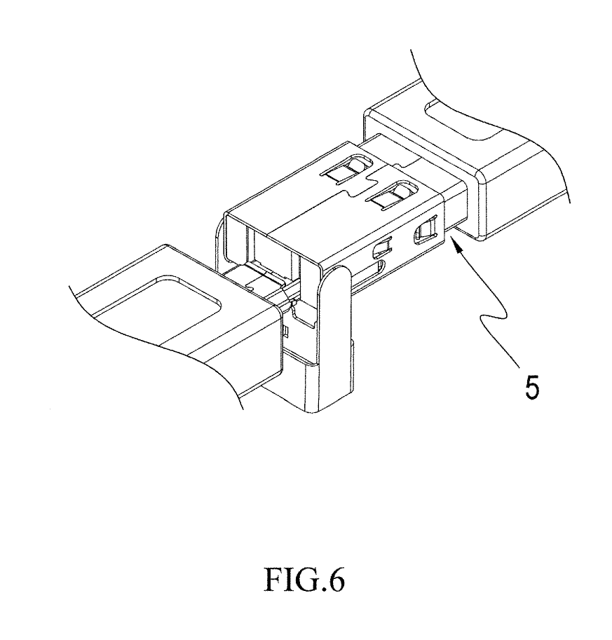

Referring to FIGS. 1-6, which are perspective views and a top plan view showing a combination of a USB (Universal Serial Bus) plug and a micro USB socket and operations thereof, these drawings clearly show that the present invention comprises the following components:

At least an insulation body 2 is provided.

A plurality of metal conductive terminals 3 is provided so as to not contact each other and form individual pins.

A first insertion port 11 is formed at one end of the accessory connector 1 and is made in a plug form. The first insertion port 11 comprises one end of the insulation body 2 and one end of each of the metal conductive terminals 3.

A second insertion port 12 is formed at an opposite end of the accessory connector 1 and is in electrical connection with the first insertion port 11 by means of the metal conductive terminals 3. The second insertion port 12 comprises an opposite end of the insulation body 2 and an opposite end of each of the metal conductive terminals 3. The second insertion port 12 is made in a socket form.

At least one shielding casing 4 receives the insulation body 2, each of the metal conductive terminals 3, the first insertion port 11, and the second insertion port 12 therein.

Firstly, an example where the first insertion port 11 is a micro USB plug and the second insertion port 12 is a USB socket provided in the instant embodiment. When a user attempts to convert a USB plug 5 into a micro USB plug by using the present invention, the user directly insert the USB plug 5 into the second insertion port 12 to be in electrical connection with the first insertion port 11, which is in the form of a micro USB socket, via the metal conductive terminals 3. Afterwards, the first insertion port 11 can be used to insert to a micro USB plug.

Further, before the above operation is carried out, a cover 6 that covers the first insertion port 11 must be first opened to allow for the subsequent use. The cover 6 provides various functions, such as dustproofness and aesthetics.

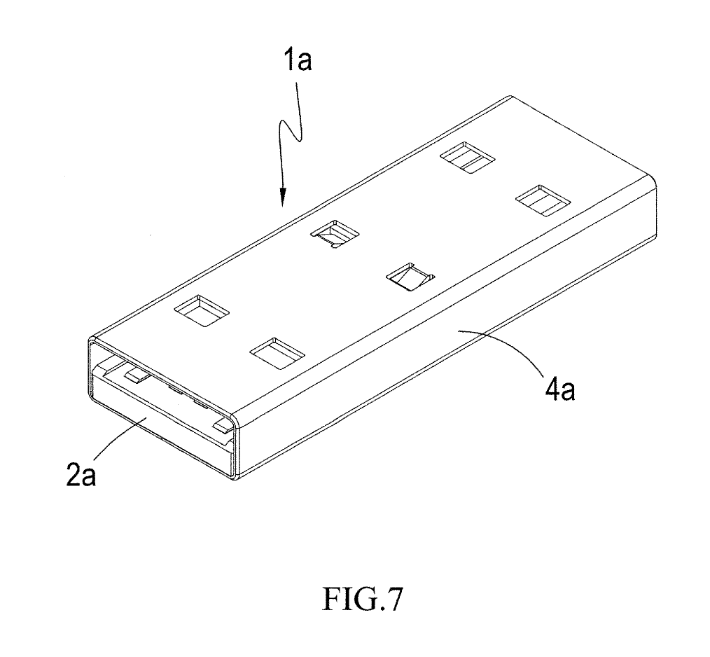

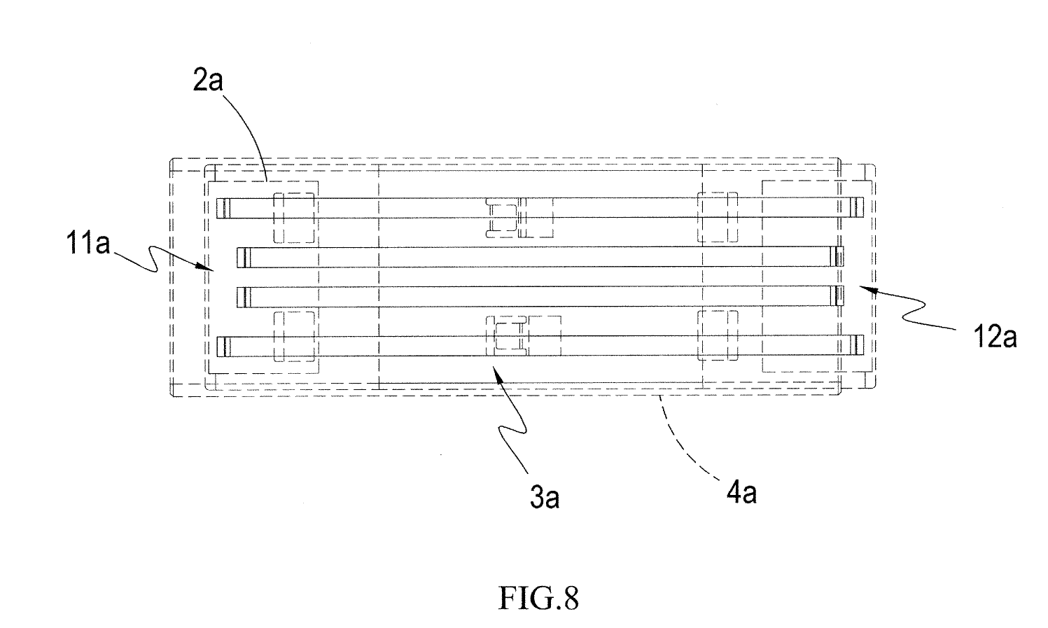

Referring to FIGS. 7 and 8, which are respectively a perspective views showing a combination of a USB plug and a USB plug and a top plan view of the combination of a USB plug and a USB plug with a casing shown in dashed lines, these drawings clearly show that the present invention comprises the following components:

At least an insulation body 2a is provided.

A plurality of metal conductive terminals 3a is provided so as to not contact each other and form individual pins.

A first insertion port 11a is formed at one end of the accessory connector 1a and is made in a plug form. The first insertion port 11a comprises one end of the insulation body 2a and one end of each of the metal conductive terminals 3a.

A second insertion port 12a is formed at an opposite end of the accessory connector 1a and is in electrical connection with the first insertion port 11a by means of the metal conductive terminals 3a. The second insertion port 12a comprises an opposite end of the insulation body 2a and an opposite end of each of the metal conductive terminals 3a. The second insertion port 12a is made in a plug form.

At least one shielding casing 4a receives the insulation body 2a, each of the metal conductive terminals 3a, the first insertion port 11a, and the second insertion port 12a therein.

As such, the operation of the instant embodiment is substantially identical to that of the previous embodiment so that repeated description will be omitted. However, the instant embodiment is different from the previously described structure in that the first insertion port 11a and the second insertion port 12a are both in a plug form to allow for conversion from a socket to a plug. Further, in the instant embodiment, both ends being USB plugs is taken as an example, but it is not limited thereto.

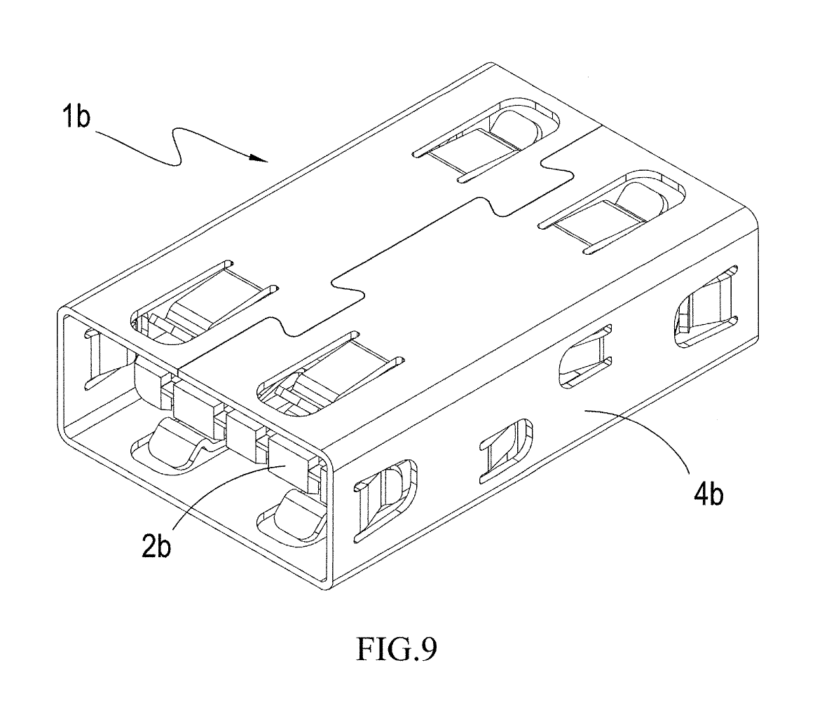

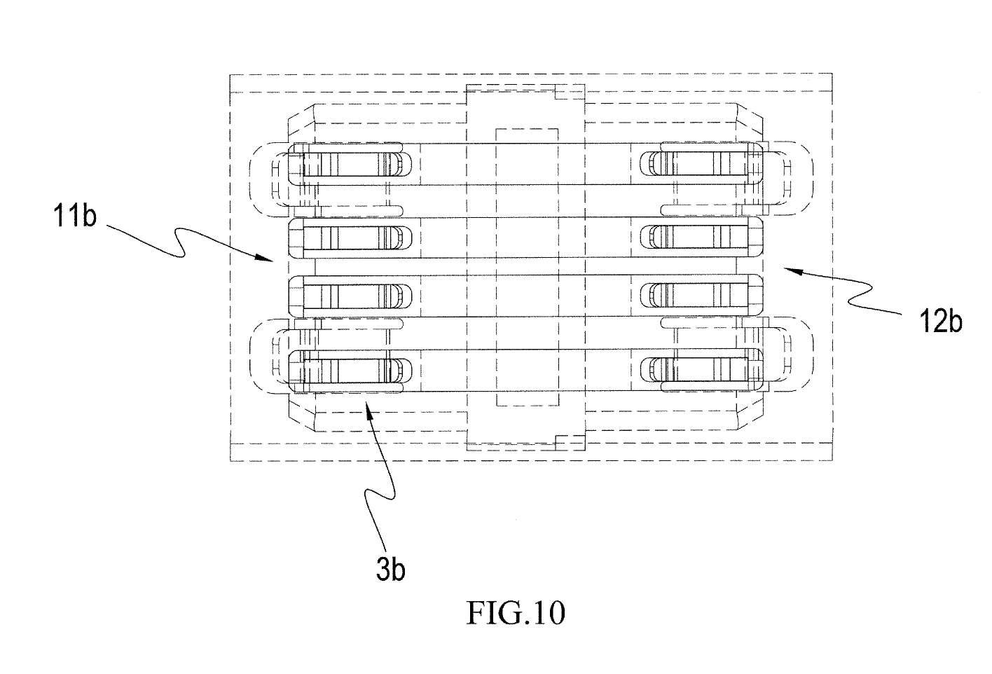

Referring to FIGS. 9 and 10, which are respectively a perspective views showing a combination of a USB socket and a USB socket and a top plan view of the combination of a USB socket and a USB socket with a casing shown in dashed lines, these drawings clearly show that the present invention comprises the following components:

At least an insulation body 2b is provided.

A plurality of metal conductive terminals 3b is mounted to the insulation body 2b and the metal conductive terminals 3b do not contact each other and form individual pins.

A first insertion port 11b is formed at one end of the accessory connector 1b and is made in a socket form. The first insertion port 11b comprises one end of the insulation body 2b and one end of each of the metal conductive terminals 3b.

A second insertion port 12b is formed at an opposite end of the accessory connector 1b and is in electrical connection with the first insertion port 11b by means of the metal conductive terminals 3b. The second insertion port 12b comprises an opposite end of the insulation body 2b and an opposite end of each of the metal conductive terminals 3b. The second insertion port 12a is made in a socket form.

At least one shielding casing 4b receives the insulation body 2b, each of the metal conductive terminals 3b, the first insertion port 11b, and the second insertion port 12b therein.

As such, the operation of the instant embodiment is substantially identical to that of the previous embodiment so that repeated description will be omitted. However, the instant embodiment is different from the previously described structure in that the first insertion port 11a is in a socket form and the second insertion port 12a is in a socket form to allow for conversion from a plug to a socket. Further, in the instant embodiment, both ends being USB sockets is taken as an example, but it is not limited thereto.

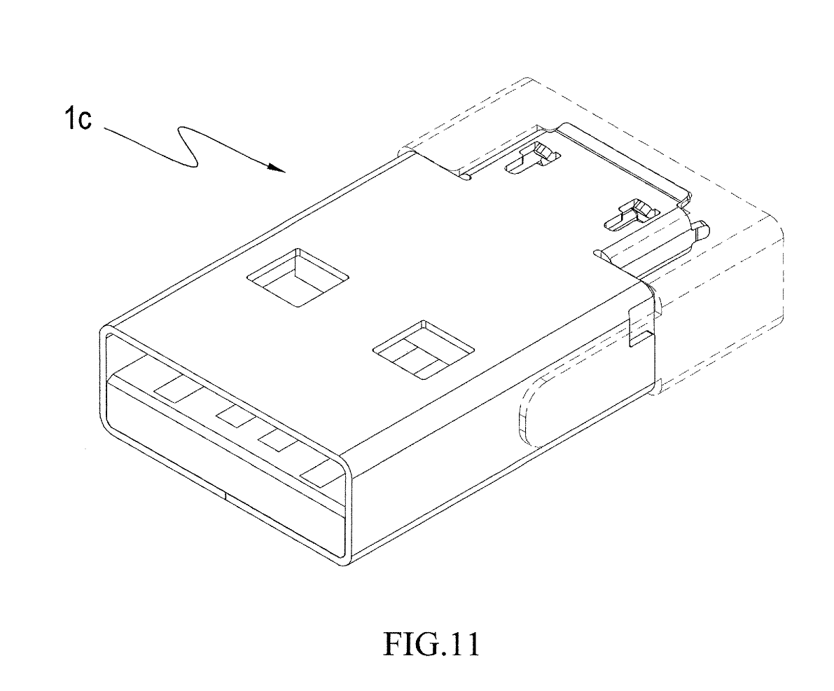

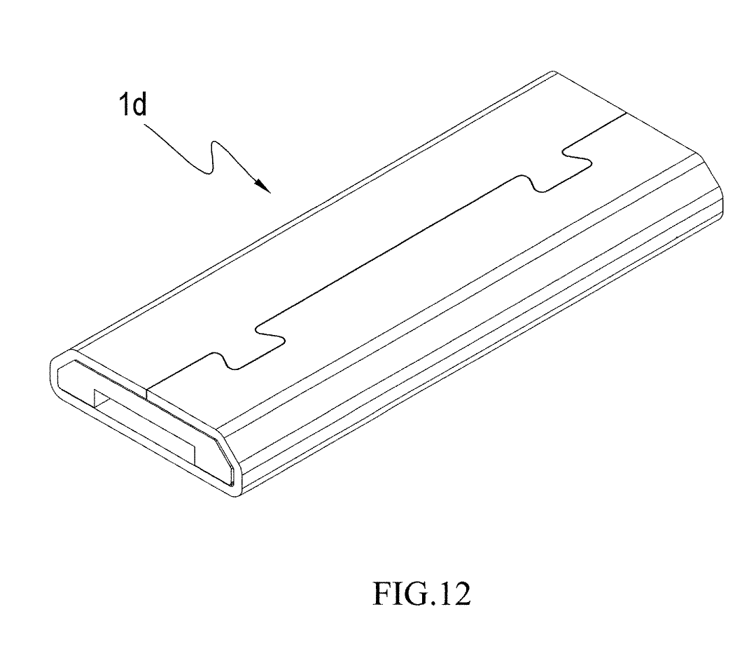

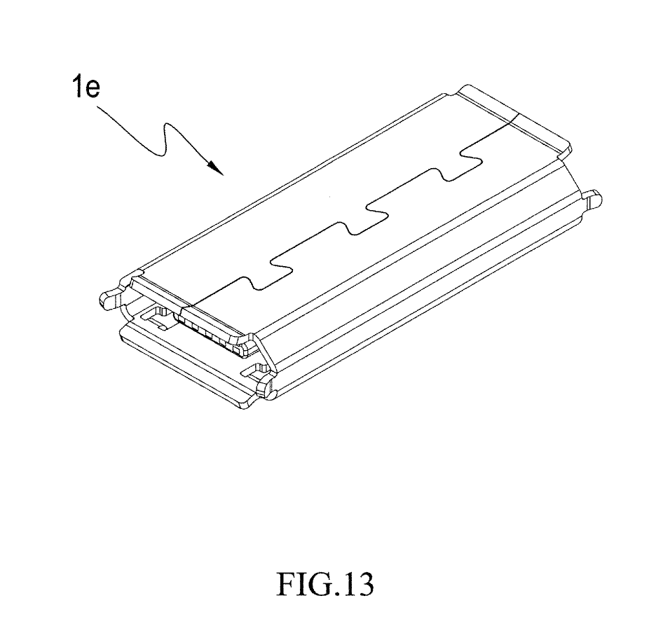

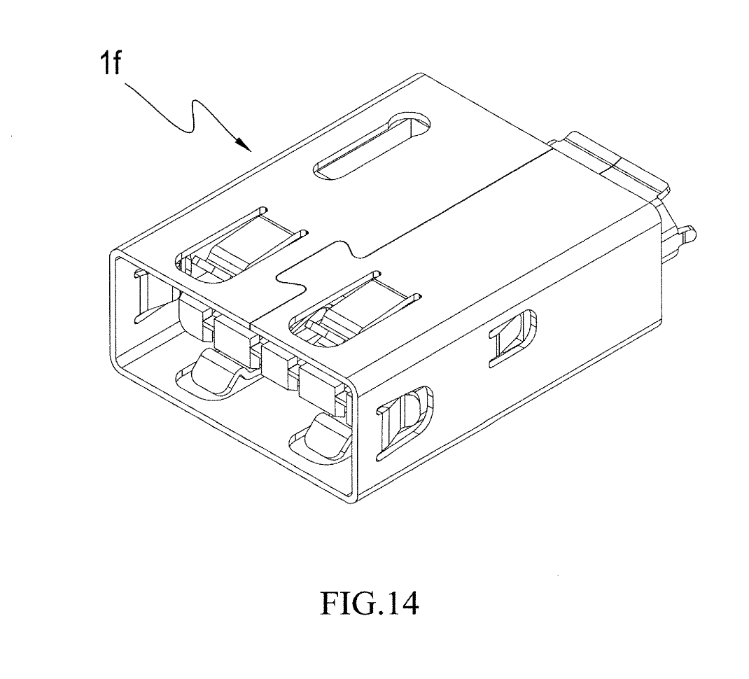

Referring to FIGS. 11 and 14, which are perspective views showing a combination of a micro USB socket and a USB plug, a combination of a micro USB plug and a micro USB plug, a combination of a micro USB socket and a micro USB socket, and a combination of a USB socket and a micro USB socket, these drawings clearly show that besides the embodiments and forms described above, the present invention also provides accessory connectors 1c, 1d, 1e, 1f that are of different forms and configurations, in which FIG. 11 shows an embodiment of a combination of a micro USB socket and a USB plug; FIG. 12 shows an embodiment of a combination of a micro USB plug and a micro USB plug; FIG. 13 shows an embodiment of a combination of a micro USB socket and a micro USB socket; and FIG. 14 shows an embodiment of a combination of a USB socket and a micro USB socket.

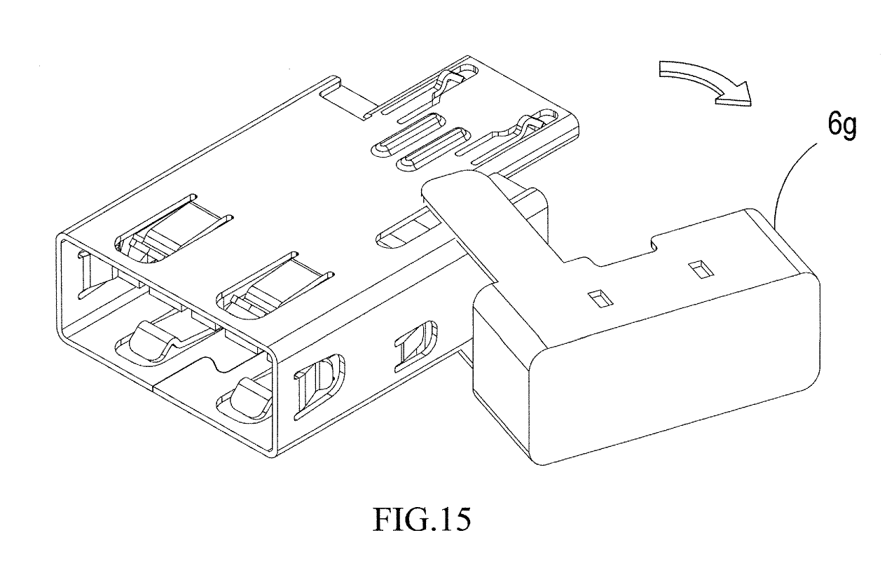

Referring to FIG. 15, which illustrates an operation of sideways rotation of a cover. The drawing clearly shows that besides being rotatable up and down, the cover 6g can be made a structure allowing for horizontal rotation.

Thus, the features that the present invention provides for overcoming the drawbacks of the prior art techniques are as follows:

Through conversion of female/male, male/male, or female/female achieved between the first insertion port 11 and the second insertion port 12, even there is only a USB interface or a micro USB interface available in a specific condition, the conversion into a micro USB interface or a USB interface can be made for proceeding with data communication.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An accessory connector comprising:
a plurality of metal conductive terminals, which is arranged not to contact each other so as to form individual pins;
a first insertion port, which is formed at one end of the accessory connector; and
a second insertion port, which is formed at an opposite end of the accessory connector and is in electrical connection with the first insertion port by means of the metal conductive terminals.

2. The accessory connector according to claim 1 further comprising at least one shielding casing and at least one insulation body received in the shielding casing, the metal conductive terminals being mounted to the insulation body, the first insertion port comprising one end of the insulation body and one end of each of the metal conductive terminals, the second insertion port comprising an opposite end of the insulation body and an opposite end of each of the metal conductive terminals.

3. An accessory connector comprising:
a plurality of metal conductive terminals, which is arranged not to contact each other so as to form individual pins;
a first insertion port, which is formed at one end of the accessory connector and is in a plug form; and
a second insertion port, which is formed at an opposite end of the accessory connector and is in electrical connection with the first insertion port by means of the metal conductive terminals, the second insertion port being in a socket form.

4. The accessory connector according to claim 3 further comprising at least one shielding casing and at least one insulation body received in the shielding casing, the metal conductive terminals being mounted to the insulation body, the first insertion port comprising one end of the insulation body and one end of each of the metal conductive terminals, the second insertion port comprising an opposite end of the insulation body and an opposite end of each of the metal conductive terminals.

5. The accessory connector according to claim 4, wherein the second insertion port is in a plug form.

6. The accessory connector according to claim 4, wherein the first insertion port is in a socket form.

7. The accessory connector according to claim 3, wherein the second insertion port is in a plug form.

8. The accessory connector according to claim 3, wherein the first insertion port is in a socket form.
